(19) United States
(12) Patent Application Publication
(10) Pub. No.: US 2009/0326065 A1
(43) Pub. Date: Dec. 31, 2009

(54) AQUEOUS PESTICIDAL COMPOSITION

(75) Inventors: Osamu Matsumoto, Osaka (JP); Lay Lee Lim, Melaka (MY)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/487,774

(22) Filed: Jun. 19, 2009

(30) Foreign Application Priority Data
Jun. 30, 2008 (JP) 2008-170237

(51) Int. Cl. A01N 53/00; A01P 15/00

(52) U.S. Cl. 514/531

(57) ABSTRACT

The present invention provides an aqueous pesticidal composition consisting of a pyrethroid compound represented by the formula (1):

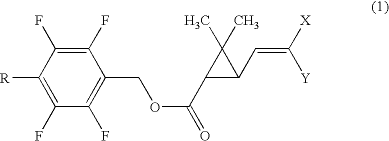

wherein R represents a hydrogen atom, a methyl group, a methoxy group or a methoxymethyl group, and X and Y independently represent a chlorine atom, a methyl group or a hydrogen atom; an alkylbenzene sulfonate, a polyoxyethylene styrenated phenyl ether having an HLB of 11 to 13, a hydrophilic solvent, water, and optionally a formulation additive, which has excellent storage stability.

### BACKGROUND OF THE INVENTION

The present invention relates to an aqueous pesticidal composition containing a pyrethroid compound represented by the formula (1) shown below.

A pyrethroid compound represented by the general formula (1):

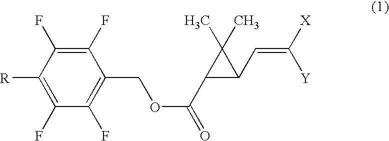

wherein R represents a hydrogen atom, a methyl group, a methoxy group or a methoxymethyl group, and X and Y independently represent a chlorine atom, a methyl group or a hydrogen atom (hereinafter referred to as the pyrethroid compound (1)) is known as a compound having pesticidal activity in U.S. Pat. No. 6,225,495 and U.S. Pat. No. 6,294,576. Furthermore, an emulsifiable concentrate containing the pyrethroid compound (1) is known in JP-A 2004-250371.

However, production of an emulsifiable concentrate containing the pyrethroid compound (1) needs use of a large amount of a hydrophobic organic solvent, which may not be good for the environment.

When a conventional aqueous pesticidal composition containing the pyrethroid compound (1) is stored for a long period of time, homogeneity of the pyrethroid compound (1) present therein decreases. Therefere, a conventional aqueous pesticidal composition containing the pyrethroid compound (1) needs a homogenization treatment immediately prior to use.

### SUMMARY OF THE INVENTION

An object of the present invention is to provide an aqueous pesticidal composition containing the pyrethroid compound (1) and having excellent long-term storage stability.

Thus, the present invention provides:

[1] An aqueous pesticidal composition consisting of a pyrethroid compound represented by the formula (1):

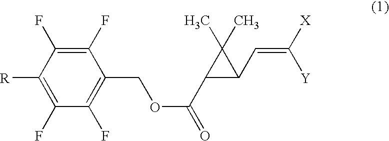

wherein R represents a hydrogen atom, a methyl group, a methoxy group or a methoxymethyl group, and X and Y independently represent a chlorine atom, a methyl group or a hydrogen atom; an alkylbenzene sulfonate, a polyoxyethylene styrenated phenyl ether having an HLB of 11 to 13, a hydrophilic solvent, water, and optionally a formulation additive;
[2] The aqueous pesticidal composition according to [1], wherein the content of water is 55% by weight or more;
[3] The aqueous pesticidal composition according to [1], wherein the contents of the pyrethroid compound, the alkylbenzene sulfonate, the polyoxyethylene styrenated phenyl ether, the hydrophilic solvent, water, and the formulation additive are respectively 1 to 10% by weight, 0.5 to 15% by weight, 2 to 20% by weight, 1 to 25% by weight, 55 to 95% by weight, and 0 to 10% by weight;
[4] The aqueous pesticidal composition according to [1], wherein the hydrophilic solvent is an alcohol having 3 to 6 carbon atoms;
[5] The aqueous pesticidal composition according to [1], wherein the weight ratios of the alkylbenzene sulfonate, the polyoxyethylene styrenated phenyl ether, and the hydrophilic solvent to the pyrethroid compound represented by the formula (1) are respectively 0.5:1 to 2:1, 2:1 to 4:1, and 1:1 to 3:1; and
[6] A process for producing a pesticidal incense stick, which comprises mixing a water dilution of the aqueous pesticidal composition according to any one of [1] to [5] with powder of a base for an incense stick, and then kneading, molding and drying the mixture.

### DETAILED DESCRIPTION OF THE PREFERRED EMBODIMENTS

In the present invention, examples of the pyrethroid compound (1) include 2,3,5,6-tetrafluoro-4-methylbenzyl 3-(1-propenyl)-2,2-dimethylcyclopropanecarboxylate, 2,3,5,6-tetrafluoro-4-methoxymethylbenzyl 3-(1-propenyl)-2,2-dimethylcyclopropanecarboxylate, 2,3,5,6-tetrafluoro-4-methoxymethylbenzyl 3-(2-methyl-1-propenyl)-2,2-dimethylcyclopropanecarboxylate, 2,3,5,6-tetrafluoro-4-methoxybenzyl 3-(1-propenyl)-2,2-dimethylcyclopropanecarboxylate and 2,3,5,6-tetrafluorobenzyl 3-(2,2-dichlorovinyl)-2,2-dimethylcyclopropanecarboxylate.

The pyrethroid compound (1) is known in U.S. Pat. No. 6,225,495 and U.S. Pat. No. 6,294,576, and can be prepared by a method described therein.

The aqueous pesticidal composition of the present invention contains usually 1 to 10% by weight of the pyrethroid compound (1).

The alkylbenzene sulfonate, as used herein, is usually a salt (sodium salt, calcium salt, ammonium salt, etc.) of benzenesulfonic acid having a C8-C14 alkyl group on the benzene ring, and a preferred example thereof is calcium dodecylbenzenesulfonate.

The aqueous pesticidal composition of the present invention contains usually 0.5 to 15% by weight of the alkylbenzene sulfonate.

Examples of the polyoxyethylene styrenated phenyl ether having an HLB of 11 to 13, as used herein, include polyoxyethylene tristyrylphenyl ether wherein an average mole number of ethylene oxide added is 14 to 18, and polyoxyethylene distyrylphenyl ether wherein an average mole number of ethylene oxide added is 10 to 14. Preferred examples of the polyoxyethylene styrenated phenyl ether having an HLB of 11 to 13 include polyoxyethylene(16) tristyrylphenyl ether (wherein the number in parenthesis denotes an average mole number of ethylene oxide added; HLB=12.5) and polyoxyethylene(12.5) distyrylphenyl ether (wherein the number in parenthesis denotes an average mole number of ethylene oxide added; HLB=12.7).

The term “HLB” means Hydrophile-Lipophile Balance. As used herein, an HLB value is calculated by the Griffin's method. However, when it is impossible to directly calculate an HLB value by the Griffin's method, a value calculated by the Devies' method or the Oda's method in which an organic conception diagram is applied is converted into a value calculated by the Griffin method.

The aqueous pesticidal composition of the present invention contains usually 2 to 20% by weight of the polyoxyethylene styrenated phenyl ether having an HLB of 11 to 13.

The hydrophilic solvent, as used herein, is a solvent miscible with water, and specifically is a solvent that can be mixed with water in a volume ratio of 1:10 to form a homogeneous liquid. Preferred examples of the hydrophilic solvent include alcohol having 3 to 6 carbon atoms.

Examples of the alcohol having 3 to 6 carbon atoms include linear monoalcohol such as n-propanol, n-butanol, n-pentanol and n-hexanol; branched monoalcohol such as isopropanol, isobutanol, branched isomers of n-pentanol and branched isomers of n-hexanol; cyclic monoalcohol such as cyclopentanol and cyclohexanol; and glycol such as propylene glycol and dipropylene glycol. In the present invention, propylene glycol is preferably used as the hydrophilic solvent.

The aqueous pesticidal composition of the present invention contains usually 1 to 25% by weight of the hydrophilic solvent.

The aqueous pesticidal composition consists of the pyrethroid compound (1), the alkylbenzene sulfonate, the polyoxyethylene styrenated phenyl ether, the hydrophilic solvent, water, and optionally a formulation additive.

The formulation additive, as used herein, is an auxiliary agent used for formulation, and examples thereof include a fungicide, a pigment and a flavor. Mixtures of the foregoing can also be employed.

Examples of the fungicide include 1,2-benzisothiazolin-3-one, 2-mercaptobenzothiazole, 2-(4-thiazolyl)benzimidazole, triforine, 3-methyl-4-isopropylphenol, and o-phenylphenol.

If the aqueous pesticidal composition of the present invention contains a formulation additive, the amount of the formulation additive is usually 10% by weight or less, preferably 0.1 to 51 by weight of the aqueous pesticidal composition.

The aqueous pesticidal composition of the present invention contains usually 55 to 95% by weight, preferably 65 to 95% by weight of water.

In the aqueous pesticidal composition of the present invention, the weight ratios of the alkylbenzene sulfonate, the polyoxyethylene styrenated phenyl ether, and the hydrophilic solvent to the pyrethroid compound (1) are preferably 0.5:1 to 2:1, 2:1 to 4:1, and 1:1 to 3:1 respectively.

The aqueous pesticidal composition of the present invention can be prepared, for example, by the following procedure.

To a mixture of the pyrethroid compound (1) and a hydrophilic solvent are added an alkylbenzene sulfonate and a polyoxyethylene styrenated phenyl ether, if necessary, under heating (80° C. or lower), followed by mixing. Then, to the resulting mixture (hereinafter referred to as the present concentrated mixture) is added water under stirring to obtain an aqueous pesticidal composition. The aqueous pesticidal composition has excellent homogeneity and its appearance is transparent. In addition, the aqueous pesticidal composition can keep the transparent appearance over a long period of time.

If necessary, the present concentrated mixture may be filtered to remove insoluble substances.

The aqueous pesticidal composition of the present invention can be used as it is. Usually, the aqueous pesticidal composition of the present invention is diluted with water before use. The aqueous pesticidal composition is usually diluted 10 to 10,000 times, preferably 20 to 5,000 times by weight with water. The water used for dilution may be either hard water (water having a large content of calcium ions and/or magnesium ions; its water hardness is expressed as ppm of carbonate corresponding to the total amount of calcium ions and magnesium ions in water) or soft water (water having a small content of calcium ions and/or magnesium ions), or may be water containing a spreading agent, an inorganic salt or the like.

The water dilution thus obtained can be used as an insecticide to be applied by hand push spraying or an aerosol insecticide. The water dilution also can be mixed with powder of a base for an incense stick, followed by kneading, molding and drying to produce a pesticidal incense stick. Furthermore, the water dilution can be used for a liquid absorbing core-type heat transpiration device.

The base for an incense stick usually consists of a combustion improver and a binder. Examples of the combustion improver include plant dry powder such as wood powder, lees powder (pyrethrum extract powder), rind powder of citrus fruits, palm oil powder, coconut shell powder and walnut shell powder; and carbon powder such as charcoal powder, activated carbon powder and coal powder, and these may be used alone or two or more of them may be used as a mixture. Examples of the binder include Tabu powder (powder of machilus thunbergii), starch (tapioca starch, corn starch, wheat starch, etc.), casein, agalloch powder, and polymer compounds such as methyl cellulose, carboxymethyl cellulose and polyvinyl alcohol, and these may be used alone or two or more of them may be used as a mixture.

### EXAMPLES

Hereinafter, the present invention will be described in more detail by way of Preparation Examples and Test Examples to which the present invention is not limited.

In the following Examples, the term “part(s)” means part(s) by weight.

In the following Examples, as the pyrethroid compound (I), 2,3,5,6-tetrafluoro-4-methoxymethylbenzyl (1R)-trans-3-(1-propenyl)-2,2-dimethylcyclopropanecarboxylate (the geometrical isomer ratio of 1-propenyl group: Z/E=about 8/1; hereinafter referred to as the pyrethroid compound A), 2,3,5,6-tetrafluoro-4-methylbenzyl (1R)-trans-3-(1-propenyl)-2,2-dimethylcyclopropanecarboxylate (the geometrical isomer ratio of 1-propenyl group: Z/E=about 8/1; hereinafter referred to as the pyrethroid compound B), 2,3,5,6-tetrafluoro-4-methoxymethylbenzyl (1R)-trans-3-(2-methyl-1-propenyl)-2,2-dimethylcyclopropanecarboxylate (hereinafter referred to as the pyrethroid compound C), or 2,3,5,6-tetrafluorobenzyl (1R)-trans-3-(2,2-dichlorovinyl)-2,2-dimethylcyclopropanecarboxylate (hereinafter referred to as the pyrethroid compound D) was used.

### Preparation Example 1

5 parts of the pyrethroid compound A, 3.5 parts of calcium dodecylbenzenesulfonate, 15 parts of polyoxyethylene(16) tristyrylphenyl ether, 1.5 parts of isobutanol, 10 parts of propylene glycol and 65 parts of deionized water were mixed by stirring to obtain an aqueous pesticidal composition 1.

### Preparation Example 2

5 parts of the pyrethroid compound A, 3.5 parts of calcium dodecylbenzenesulfonate, 15 parts of polyoxyethylene(16) tristyrylphenyl ether, 11.5 parts of isobutanol and 65 parts of deionized water were mixed by stirring to obtain an aqueous pesticidal composition 2.

### Preparation Example 3

5 parts of the pyrethroid compound A, 3.5 parts of calcium dodecylbenzenesulfonate, 15 parts of polyoxyethylene(16) tristyrylphenyl ether, 1.5 parts of isobutanol, 10 parts of dipropylene glycol and 65 parts of deionized water were mixed by stirring to obtain an aqueous pesticidal composition 3.

### Preparation Example 4

5 parts of the pyrethroid compound B, 3.5 parts of calcium dodecylbenzenesulfonate, 15 parts of polyoxyethylene(16) tristyrylphenyl ether, 1.5 parts of isobutanol, 10 parts of propylene glycol and 65 parts of deionized water were mixed by stirring to obtain an aqueous pesticidal composition 4.

### Preparation Example 5

5 parts of the pyrethroid compound C, 3.5 parts of calcium dodecylbenzenesulfonate, 15 parts of polyoxyethylene(16) tristyrylphenyl ether, 1.5 parts of isobutanol, 10 parts of propylene glycol and 65 parts of deionized water were mixed by stirring to obtain an aqueous pesticidal composition 5.

### Preparation Example 6

5 parts of the pyrethroid compound D, 3.5 parts of calcium dodecylbenzenesulfonate, 15 parts of polyoxyethylene(16) tristyrylphenyl ether, 1.5 parts of isobutanol, 10 parts of propylene glycol and 65 parts of deionized water were mixed by stirring to obtain an aqueous pesticidal composition 6.

### Preparation Example 7

5 parts of the pyrethroid compound A, 3.5 parts of calcium dodecylbenzenesulfonate, 15 parts of polyoxyethylene(12.5) distyrylphenyl ether, 1.5 parts of isobutanol, 10 parts of propylene glycol and 65 parts of deionized water were mixed by stirring to obtain an aqueous pesticidal composition 7.

### Preparation Example 8

The aqueous pesticidal composition 1 obtained in Preparation Example 1 is diluted 10-fold with deionized water to obtain a water dilution containing 0.05 parts of the pyrethroid compound A, 0.035 parts of calcium dodecylbenzenesulfonate, 0.15 parts of polyoxyethylene(16) tristyrylphenyl ether, 0.015 parts of isobutanol, 0.1 parts of propylene glycol and 99.65 parts of deionized water.

### Preparation Example 9

50 parts of the water dilution obtained in Preparation Example 8, 15 parts of pyrethrum extract powder, 15 parts of wood powder, 20 parts of Tabu powder and 10 parts of water were mixed, well kneaded, molded and then dried (at 40° C. for 6 hours) to obtain an pesticidal incense stick.

### Comparative Preparation Example 1

5 parts of the pyrethroid compound A, 3.5 parts of calcium dodecylbenzenesulfonate, 15 parts of polyoxyethylene(16) tristyrylphenyl ether, 1.5 parts of isobutanol, 10 parts of xylene and 65 parts of deionized water were mixed by stirring to obtain a comparative composition 1.

### Comparative Preparation Example 2

5 parts of the pyrethroid compound A, 3.5 parts of calcium dodecylbenzenesulfonate, 15 parts of polyoxyethylene(8) nonylphenyl ether (HLB=12.3), 1.5 parts of isobutanol, 10 parts of propylene glycol and 65 parts of deionized water were mixed by stirring to obtain a comparative composition 2.

### Comparative Preparation Example 3

5 parts of the pyrethroid compound A, 3.5 parts of calcium dodecylbenzenesulfonate, 15 parts of polyoxyethylene(10) tristyrylphenyl ether (HLB=10.4), 1.5 parts of isobutanol, 10 parts of propylene glycol and 65 parts of deionized water were mixed by stirring to obtain a comparative composition 3.

### Comparative Preparation Example 4

5 parts of the pyrethroid compound A, 3.5 parts of calcium dodecylbenzenesulfonate, 15 parts of polyoxyethylene(20) tristyrylphenyl ether (HLB=13.7), 1.5 parts of isobutanol, 10 parts of propylene glycol and 65 parts of deionized water were mixed by stirring to obtain a comparative composition 3.

### Test Example 1

The aqueous pesticidal compositions 1, 2 and 3 obtained in Preparation Examples 1, 2 and 3, the water dilution obtained in Preparation Example 8, and the comparative compositions 1, 2, 3 and 4 obtained in Comparative Preparation Examples 1, 2, 3 and 4 were stored at 5° C. for 1 week.

After 1 week, the aqueous pesticidal compositions 1, 2 and 3 and the water dilution of Preparation Example 8 remained in a transparent state, while the comparative compositions 1, 2, 3 and 4 changed from a transparent state immediately after preparation into a white turbid state.

### Test Example 2

Into two glass tubes having a height of 12 cm and an inner diameter of 4 cm (whose both ends were closed with 16 mesh nylon nets), 5 female imagoes of Culex pipiens pallens were released. On top of a test cylinder having a height of 80 cm and a diameter of 20 cm, a metal pedestal having a width of 7.8 cm for the glass tubes was laid across the diameter of the test cylinder. The pedestal was provided with two symmetrical holes having the same diameter (4 cm) as the inner diameter of the glass tube, which were located 4 cm away from the center of the cylinder. On the pedestal, the glass tubes containing imagoes of Culex pipiens pallens were placed, thereby allowing an air current from beneath the test cylinder to pass through the glass tubes. A transparent resin cylinder for observation having a diameter of 20 cm and a height of 30 cm was installed on top of the test cylinder so that their outer diameters could be joined together.

The pesticidal incense stick obtained in Preparation Example 9 was ignited and then placed on the bottom of the test cylinder. After 5 minutes, the number of knocked-down female imagoes of Culex pipiens pallens was counted. As a result, all five imagoes tested were knocked down.

### INDUSTRIAL APPLICABILITY

According to the present invention, an aqueous pesticidal composition containing the pyrethroid compound (I) which keeps good homogeneity of the pyrethroid compound (I) during storage over a long period of time and therefore is easy to handle can be prepared. Thus, for example, the aqueous pesticidal composition of the present invention can be used for producing a pesticidal incense stick.

What is claimed is:

1. An aqueous pesticidal composition consisting of a pyrethroid compound represented by the formula (1): 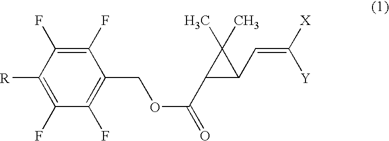
wherein R represents a hydrogen atom, a methyl group, a methoxy group or a methoxymethyl group, and X and Y independently represent a chlorine atom, a methyl group or a hydrogen atom; an alkylbenzene sulfonate, a polyoxyethylene styrenated phenyl ether having an HLB of 11 to 13, a hydrophilic solvent, water, and optionally at least one formulation additive.

2. The aqueous pesticidal composition according to claim 1, wherein the content of water is 55% by weight or more.

3. The aqueous pesticidal composition according to claim 1, wherein the contents of the pyrethroid compound, the alkylbenzene sulfonate, the polyoxyethylene styrenated phenyl ether, the hydrophilic solvent, water, and the formulation additive are respectively 1 to 10% by weight, 0.5 to 15% by weight, 2 to 20% by weight, 1 to 25% by weight, 55 to 95% by weight, and 0 to 10% by weight.

4. The aqueous pesticidal composition according to claim 1, wherein the hydrophilic solvent is an alcohol having 3 to 6 carbon atoms.

5. The aqueous pesticidal composition according to claim 1, wherein the weight ratios of the alkylbenzene sulfonate, the polyoxyethylene styrenated phenyl ether, and the hydrophilic solvent to the pyrethroid compound represented by the formula (1) are respectively 0.5:1 to 2:1, 2:1 to 4:1, and 1:1 to 3:1.

6. A process for producing a pesticidal incense stick, which comprises mixing a water dilution of the aqueous pesticidal composition according to claim 1 with powder of a base for an incense stick, and then kneading, molding and drying the mixture.

7. A process for producing a pesticidal incense stick, which comprises mixing a water dilution of the aqueous pesticidal composition according to claim 2 with powder of a base for an incense stick, and then kneading, molding and drying the mixture.

8. A process for producing a pesticidal incense stick, which comprises mixing a water dilution of the aqueous pesticidal composition according to claim 3 with powder of a base for an incense stick, and then kneading, molding and drying the mixture.

9. A process for producing a pesticidal incense stick, which comprises mixing a water dilution of the aqueous pesticidal composition according to claim 4 with powder of a base for an incense stick, and then kneading, molding and drying the mixture.

10. A process for producing a pesticidal incense stick, which comprises mixing a water dilution of the aqueous pesticidal composition according to claim 5 with powder of a base for an incense stick, and then kneading, molding and drying the mixture.
